(19) United States
(12) Patent Application Publication
(10) Pub. No.: US 2025/0018409 A1
(43) Pub. Date: Jan. 16, 2025

(54) ASSEMBLY OF A CUP, LINER AND LID FOR A PAINT SPRAY GUN

(71) Applicant: CHEMICAR EUROPE NV, Zwijndrecht (BE)

(72) Inventors: Alain Marcel Wambeke, Zwijndrecht (BE); Dirk Van Driessche, Zwijndrecht (BE); Piet Jan Ernst Greeve, Zwijndrecht (BE)

(73) Assignee: CHEMICAR EUROPE NV, Zwijndrecht (BE)

(21) Appl. No.: 18/710,060

(22) PCT Filed: Nov. 17, 2022
(86) PCT No.: PCT/IB2022/061061

§ 371 Date: May 14, 2024

(30) Foreign Application Priority Data
Nov. 18, 2021 (BE) 2021/5893

(51) Int. Cl. B05B 7/24

(52) U.S. Cl. CPC B05B 7/2481; B05B 7/2478

(57) ABSTRACT

An assembly for use with a spray gun includes a lid with a passage for a liquid, a cup and a liner configured to be arranged in the cup. The lid is configured to be removably couplable to the cup such that in a coupled state of the lid on the cup an upper end of the liner is clamped between the lid and the cup. The lid is provided with an inner peripheral wall configured to extend at least partially into the cup. The inner peripheral wall has an outer surface lying opposite an inner surface. The outer surface of the inner peripheral wall and/or the inner surface of the cup is provided with at least one seal.

### FIELD OF THE INVENTION

The field of the invention relates to assemblies of a lid, a cup and a liner for a liquid, such as a paint mixture, and particularly to a lid for use in such assemblies, a liner for use in such assemblies and a cup for use in such assemblies. The lid is configured for removable coupling to the cup. The lid is provided with a passage for the liquid, wherein the passage is preferably configured to be coupled to a spray gun for spraying the liquid.

### PRIOR ART

Such an assembly of a lid, a cup and a liner is known. Such an assembly can be mounted on a paint spray gun, wherein the lid is coupled to an inlet of the paint spray gun such that paint can flow from the liner to the paint spray gun. In such systems it is known to provide an opening in the cup or in the lid such that air can be supplied in the case of a possible underpressure in the cup, this in order to empty the liner more easily.

### SUMMARY

Some embodiments of the invention have the object of providing an assembly of a lid, a cup and a liner whereby a liner can be clamped between the lid and the cup in an improved manner.

According to a first aspect of the invention, an assembly comprising a lid, a cup and a liner is provided. The lid has a passage for a liquid, wherein the passage is preferably configured to be coupled to a spray gun for spraying the liquid. The liner is configured to receive the liquid and to be arranged in the cup. The lid is configured to be removably couplable to the cup, all this such that in a coupled state of the lid on the cup an upper end of the liner is clamped between the lid and the cup. The lid is provided with an inner peripheral wall which is configured to extend at least partially into the cup, wherein the inner peripheral wall has an outer surface lying opposite an inner surface of the cup. The outer surface of the inner peripheral wall and/or the inner surface of the cup is provided with at least one seal, such that the upper end of the liner is clamped sealingly between the cup and the inner peripheral wall of the lid.

By providing at least one seal which acts between the outer surface of the inner peripheral wall of the lid and the inner surface of the cup, and which engages against the upper end of the liner, the liner can be clamped sealingly between the lid and the cup.

The outer surface of the inner peripheral wall is preferably formed with the at least one seal, i.e. the at least one seal preferably forms an integral part of the lid. In this way no special modification of the cup is necessary, and a good, sealing fastening of the liner between cup and lid can be obtained in simple manner.

The at least one seal preferably comprises an annular seal which protrudes from the outer surface of the inner peripheral wall and/or an annular seal which protrudes from the inner surface of the cup. The annular seal can thus for instance be formed on the lid or on the cup.

The lid is preferably provided with an upper wall which is configured to extend over an upper end of the cup, wherein the upper wall has an inner surface lying opposite an upper surface close to the upper end of the cup; wherein the inner surface of the upper wall and/or the upper surface of the cup is provided with at least one further seal, such that the upper end of the liner is clamped sealingly between the cup and the upper wall of the lid. In this way a double seal is obtained: a first seal between the inner peripheral wall of the lid and an inner surface of the cup, and a second seal between the upper wall of the lid and the upper end of the cup.

The at least one further seal preferably comprises an annular seal which protrudes from the inner surface of the cup and/or an annular seal which protrudes from the upper surface of the upper end of the cup. The annular seal can for instance be formed integrally on the lid and/or on the cup.

The lid is preferably provided not only with an inner peripheral wall which protrudes into the cup, but also with an outer peripheral wall which is configured to be in contact with an outer surface of the cup. In this way the upper end of the cup can be situated between the inner and outer peripheral wall, and a good fastening of the lid on the cup is obtained. In such an embodiment, the inner peripheral wall, an upper peripheral wall and the outer peripheral wall thus form a U-shaped peripheral channel which is open on an underside for the purpose of receiving therein the upper end of the cup.

The outer surface of the cup is preferably provided with and particularly formed with a screw thread, and an inner surface of the outer peripheral wall is preferably provided with and particularly formed with a complementary screw thread. The screw thread can for instance consist of a plurality of parts which are arranged distributed over the periphery of the cup. The complementary screw thread can similarly consist of a plurality of parts which are arranged distributed over the periphery of the cup. A progressive screw thread can optionally be provided so that an additional seal is obtained.

According to a second aspect of the invention, an assembly comprising a lid, a cup and a liner is provided. The lid has a passage for a liquid, wherein the passage is preferably configured to be coupled to a spray gun for spraying the liquid. The liner is configured to receive the liquid and to be arranged in the cup. The lid is configured to be removably couplable to the cup, all this such that in a coupled state of the lid on the cup an upper end of the liner is clamped between the lid and the cup. The cup has a bottom and an upright wall which is provided with a step-like upper end. The step-like upper end comprises a first peripheral wall which forms an angle with a part of the upright wall lying thereunder, and a second peripheral wall which is connected to the first peripheral wall and lies at an angle relative to the first peripheral wall. The first peripheral wall can for instance be oriented roughly parallel to the bottom. The liner is clamped between the first peripheral wall of the cup and the lid.

The liner can then be provided with an outward directed flange which is intended to lie over the first peripheral wall. Owing to the angle formed by the first peripheral wall with a part of the upright wall lying thereunder, a good positioning and alignment of the liner in the cup is obtained and a more robust and better camping is achieved.

The first peripheral wall is preferably substantially parallel to the bottom or the first peripheral wall preferably forms an angle smaller than 20° with a plane parallel to the bottom.

The first peripheral wall preferably lies at an angle of between 70° and 110° relative to a part of the upright wall lying thereunder; and/or the second peripheral wall preferably lies at an angle of between 70° and 110° relative to the first peripheral wall.

The lid is preferably provided with an upper wall which is configured to extend over the first peripheral wall, wherein the upper wall has an inner surface lying opposite an upper surface of the first peripheral wall. The inner surface of the upper wall and/or the upper surface of the first peripheral wall is preferably provided with, more preferably formed with, at least one seal such that the upper end of the liner is clamped sealingly between the cup and the upper wall of the lid. The at least one seal preferably comprises an annular seal which protrudes from the inner surface of the lid and/or an annular seal which protrudes from the upper surface of the first peripheral wall of the cup. The annular seal can for instance be formed integrally on the lid or on the cup.

The lid is preferably provided with an inner peripheral wall which is configured to extend at least partially into the cup, wherein the inner peripheral wall has an outer surface lying opposite an inner surface of the cup. The outer surface of the inner peripheral wall and/or the inner surface of the cup can then be provided with at least one seal, such that the upper end of the liner is also clamped sealingly between the cup and the inner peripheral wall of the lid. This provides for a double seal, as already described above.

The lid preferably has an outer peripheral wall which is configured to be in contact with the second peripheral wall of the cup. The second peripheral wall can optionally be provided with and particularly be formed with a screw thread, and the outer peripheral wall of the lid is optionally provided with and particularly formed with a complementary screw thread. The cup can optionally be provided with a stop for the lid, and particularly for the outer peripheral wall of the lid. The stop can for instance be a peripheral flange which extends outward from the second peripheral wall of the cup.

Some embodiments of the invention have the object of providing an assembly of a lid, a cup and a liner, wherein the liner can be sprayed empty more effectively compared to existing liners.

According to a third aspect of the invention, an assembly comprising a lid, a cup and a liner is provided. The lid has a passage for a liquid, wherein the passage is preferably configured to be coupled to a spray gun for spraying the liquid. The cup has a bottom and an upright side wall. The liner is configured to be arranged in the cup. The lid is configured to be removably couplable to the cup, all this such that in a coupled state of the lid on the cup an upper end of the liner is clamped between the lid and the cup. The liner is manufactured from a polyethylene terephthalate (PET) material.

By manufacturing the liner from a PET material a liner can be obtained which is relatively stiff yet is still readily collapsible/compressible. The liquid further sticks to the liner to lesser extent than in existing liners which are for instance manufactured from an LDPE material. These properties ensure that the liner can on one hand be readily positioned in the cup owing to the stiffness of the liner, and can on the other hand be sprayed empty properly owing to the good compressibility/collapsibility and the liquid-repellent properties.

According to a fourth aspect of the invention, an assembly comprising a lid, a cup and a liner is provided. The lid has a passage for a liquid, wherein the passage is preferably configured to be coupled to a spray gun for spraying the liquid. The cup has a bottom and an upright side wall. The liner is configured to be arranged in the cup. The lid is configured to be removably couplable to the cup, all this such that in a coupled state of the lid on the cup an upper end of the liner is clamped between the lid and the cup. The liner has a cup shape with a jacket with a wall thickness lying between 10 and 250 micrometres, preferably between 10 and 200 micrometres, still more preferably between 10 and 150 micrometres, for instance between 10 and 130 micrometres.

The liner can for instance be manufactured from an amorphous material, for instance a PET material, but could also be manufactured from a combination of materials, for instance a laminate material such as PET and paper, a biomaterial, and so on.

By making the jacket of the liner thin, i.e. with a wall thickness lying between 10 and 250 micrometres, a good compressibility/collapsibility is obtained and the liner can be sprayed empty easily.

According to a fifth aspect of the invention, an assembly comprising a lid, a cup and a liner is provided. The lid has a passage for a liquid, wherein the passage is preferably configured to be coupled to a spray gun for spraying the liquid. The cup has a bottom and an upright side wall. The liner is configured to be arranged in the cup. The lid is configured to be removably couplable to the cup, all this such that in a coupled state of the lid on the cup an upper end of the liner is clamped between the lid and the cup. The liner has a cup shape and is manufactured from a material with an elastic modulus, measured in accordance with testing method ISO 527-2, lying between 1000 MPa and 4000 MPa, preferably between 2000 MPa and 3000 Mpa.

The liner can for instance be manufactured from an amorphous material, for instance a PET material, but could also be manufactured from a combination of materials, for instance a laminate material such as PET and paper, a biomaterial, and so on.

The liner preferably has a jacket with a wall thickness smaller than 250 micrometres, preferably smaller than 200 micrometres, still more preferably smaller than 150 micrometres, for instance smaller than 130 micrometres.

By opting for a relatively high elastic modulus for the material of the liner a thin but relatively stiff liner can be obtained, which can be manufactured in a cup shape yet is still easily compressible/collapsible during spraying.

Further preferred features which are described below can be combined with any of the above described aspects.

The liner is preferably manufactured by thermoforming or by blow moulding. The liner is preferably manufactured from a film by thermoforming, wherein a film material with good deep-drawing properties is more preferably opted for.

The liner preferably has the shape of a cup. The liner more preferably has a bottom, an upright side wall (also referred to above as jacket), and an outward directed peripheral flange. The peripheral flange protrudes outward from the upright side wall and is intended to extend between the cup and the lid. A downward directed peripheral wall, which protrudes downward from the peripheral flange and is intended to lie between an outer surface of the cup and an outer peripheral wall of the lid, can optionally further be provided.

The liner preferably has the shape of a cup with an upright wall which is provided with a bend, all this such that when the liner is placed in a second, identical liner, the bend is supported on an upper end of the second liner. The bend thus forms a stacking edge whereby the liners are easily stackable. In this way a plurality of liners can be picked up in a combined set in simple manner. The cup can then be provided with a corresponding bend in the upright wall thereof, such that the liner can be positioned properly in the cup.

A ratio of the weight of the liner and the volume which can be received in the liner preferably lies between 3 g/l and 16 g/l, preferably between 4 g/l and 10 g/l. The weight of the liner preferably lies between 1 g and 6 g, preferably between 1 g and 5 g, still more preferably between 2 g and 5 g. The volume of liquid which can be received in the liner preferably lies between 200 and 900 ml.

Several examples of suitable liners are:
A liner for a volume of 600-700 ml which is thermoformed from a PET film with a thickness of between 300 and 400 micrometres, with a weight of between 2 g and 6 g, and a wall thickness of between 10 and 150 micrometres;
A liner for a volume of 200-300 ml which is thermoformed from a PET film with a thickness of between 300 and 400 micrometres, with a weight of between 1 g and 4 g, and a wall thickness of between 10 and 150 micrometres;
A liner for a volume of 800-900 ml which is thermoformed from a PET film with a thickness of between 400 and 500 micrometres, with a weight of between 3 g and 7 g, and a wall thickness of between 10 and 150 micrometres;

The liner is preferably manufactured from a material with a specific weight, measured at 23° C. in accordance with the ISO 1183 measuring method, which is greater than 1 g/cm³, and which more preferably lies between 1 and 3 g/cm³.

In a possible embodiment the cup is manufactured from a polypropylene material.

The cup preferably has a side wall with a wall thickness greater than 500 micrometres.

In a possible embodiment the lid has a conical or spherical part which lies adjacently of the passage. In this way the liquid is guided readily to the passage.

In a possible embodiment the assembly comprises a filter for filtering liquid flowing from the liner to the passage in the lid. The filter is preferably arranged against an underside of the lid. The filter for instance takes the form of a screen mesh. If the lid comprises a conical or spherical part, a flat edge against which the filter is mounted can optionally be provided on the inner side of the conical or spherical part (for instance by providing a step-like part in the lid). The filter can also be mounted against a flat part which extends around the conical or spherical part. The diameter of the filter can thus be roughly the same as that of the whole lid, or can be smaller. The diameter of the filter can for instance lie between 50 mm and 120 mm. The filter is preferably arranged such that the collapsed liner does not touch the filter while the liner is being sprayed empty.

The cup is preferably formed with a bottom and an upright wall extending from the bottom, wherein the bottom is provided with one or more openings, more preferably a plurality of openings distributed along the periphery of the bottom. These one or more openings ensure that no underpressure builds up in the cup during spraying. According to another possible embodiment, one or more openings can be provided in the upright wall of the cup and/or in the lid.

According to a possible embodiment, the assembly further comprises a stopper or a cap configured to be removably arrangeable over or in the passage in the lid in order to close the passage. The stopper can for instance be provided with a cylindrical or conical part which can be inserted sealingly into the passage, and an upper flange which protrudes outward relative to the cylindrical or conical part. The stop can then be inserted/removed in simple manner by taking hold of the upper flange thereof.

The upper flange preferably has a flat upper side such that the assembly can also be placed upside down, wherein the support surface is formed by the upper flange of the stopper. The upper flange preferably extends diametrically relative to the cylindrical or conical part over a distance of at least 5 mm. The upper flange can for instance be formed with one or more protruding legs or wings which are arranged distributed uniformly around a central axis of the cylindrical or conical part and are configured to form a support when the assembly is placed upside down on a flat surface. In this way the assembly can be placed on the cap or stopper following spraying if any paint remains in the cup, such that if a filter is present (for instance a screen mesh), this filter remains submerged and does not dry out.

The invention further relates to a liner for use in an assembly according to any one of the above described embodiments, to a cup for use in an assembly according to any one of the above described embodiments, to a lid for use in an assembly according to any one of the above described embodiments, and to a cap or stopper for use in an assembly according to any one of the above described embodiments. The skilled person will appreciate that a set of a variety of liners and a plurality of lids is typically provided for one cup, since a cup is easily reusable.

According to yet another aspect, the invention relates to a liner for receiving a liquid, such as a paint mixture, wherein the liner is configured to be arranged in a cup; wherein the liner has a bottom, an upright side wall and a peripheral flange, which peripheral flange protrudes outward from the upright side wall and is intended to extend over an edge of the cup; wherein the liner is manufactured from a polyethylene terephthalate (PET) material. The upright wall preferably has a wall thickness lying between 10 and 250 micrometres; wherein a ratio of the weight of the liner and the volume which can be received in the liner preferably lies between 2 g/l and 16 g/l.

Such a liner can be arranged in a cup with substantially the same shape, wherein a lid can optionally be arranged on the cup. The cup with liner can however also be used without lid for the purpose of mixing and/or measuring the liquid. Owing to the choice of material and the choice of wall thickness, a liner is obtained which is collapsible yet still sufficiently form-retaining, wherein the shape can be adapted to the shape of the cup in which the liner is arranged in use. By using a weight/volume ratio which lies between 2 g/l and 16 g/l a good compromise is obtained between weight, collapsibility and strength.

The PET material is preferably translucent or transparent. The PET material preferably has a haze value, measured in accordance with the ASTM D1003 standard, lying between 0.4 and 1.5%. The transparency of the PET material preferably amounts to between 80 and 100%. The PET material can be any suitable PET material, for instance amorphous PET, PET-G (polyethylene terephthalate glycol-modified), recycled PET.

The liner preferably has a cup shape with a jacket (upright side wall) with a wall thickness lying between 10 and 250 micrometres, more preferably between 10 and 200 micrometres, still more preferably between 10 and 150 micrometres, most preferably between 40 and 150 micrometres. The bottom of the liner preferably has a wall thickness which is slightly greater than the wall thickness of the upright side wall, although this will typically also lie between 10 and 300 micrometres. In other embodiments the wall thickness of the bottom can also be smaller than or roughly equal to the wall thickness of the upright side wall. The liner is preferably manufactured from a material with an elastic modulus, measured in accordance with testing method ISO 527-2, lying between 1000 MPa and 4000 MPa, more preferably between 2000 MPa and 3000 Mpa. Advantages of these properties have already been elucidated above.

Further advantageous properties of the liner are:
a ratio of the weight of the liner and the volume which can be received in the liner lies between 2.5 g/l and 16 g/l, preferably between 3 g/l and 16 g/l, more preferably between 4 g/l and 10 g/l; and/or
the weight of the liner lies between 1 g and 6 g, preferably between 1 g and 5 g, still more preferably between 2 g and 5 g; and/or
the volume of liquid which can be received in the liner lies between 200 and 5000 ml, preferably between 200 and 900 ml; and/or
the ratio of a height of the liner and a maximum diameter of the liner is smaller than 1.7, preferably smaller than 1.5. In this way a compromise is achieved between being able to accurately read the quantity of liquid in the cup (the higher the more accurate) and a good mixing (the greater the diameter, the better).

Several examples of suitable liners are:
A liner for a volume of 200-300 ml which is thermoformed from a PET film with a thickness of between 150 and 400 micrometres, for instance between 300 and 400 micrometres, with a weight of between 1 g and 4 g, and a wall thickness of between 10 and 150 micrometres;
A liner for a volume of 350-500 ml which is thermoformed from a PET film with a thickness of between 250 and 400 micrometres, for instance between 300 and 400 micrometres, with a weight of between 1 g and 5 g, for instance between 1 g and 4 g, and a wall thickness of between 10 and 150 micrometres;
A liner for a volume of 600-700 ml which is thermoformed from a PET film with a thickness of between 300 and 400 micrometres, with a weight of between 2 g and 6 g, for instance between 3 g and 5 g, and a wall thickness of between 10 and 150 micrometres;
A liner for a volume of 800-900 ml which is thermoformed from a PET film with a thickness of between 400 and 500 micrometres, with a weight of between 3 g and 7 g, and a wall thickness of between 10 and 150 micrometres;
A liner for a volume of 1000-5000 ml, for instance 1000-2000 ml, which is thermoformed from a PET film with a thickness of between 400 and 1000 micrometres, for instance between 400 and 500 micrometres, with a weight of between 3 g and 15 g, for instance between 3 g and 7 g, and a wall thickness of between 10 and 150 micrometres.

The advantages of these properties have already been described above. The more specific examples stated above are also applicable for liners used without lid.

The liner is preferably arrangeable in another, identical liner, all this such that the liners are easily stackable. In this way liners can also be packaged in simple manner, for instance per 10 or more liners, or per 100 or more liners.

In a possible embodiment the liner has the shape of a cup with an upright side wall which is provided with a bend, all this such that when the liner is placed in a second, identical liner, the bend is supported on an upper end of the second liner.

The liner can optionally be provided with measurement indications and/or mixing indications. These can for instance be printed onto the liner. Measurement indications indicate the quantity of liquid in the liner. Mixing indications can for instance comprise a first indication for a quantity of first liquid and a second indication for addition of a second liquid, and optionally a third indication for addition of a third liquid. The mixing indications can for instance comprise indications for a 2:1, 3:1, etc. mixing ratio.

According to yet another aspect, an assembly is provided comprising a liner according to any one of the above discussed embodiments and a cup in which the liner is receivable.

The cup is preferably a measuring cup provided with measurement indications and/or mixing indications such as measurement marks, mixing ratios, and so on. Such measurement indications and/or mixing indications can for instance be printed onto the cup. According to an alternative, an IML (In Mould Label) film can be arranged in the mould which is used to form the cup, and the measurement indications and/or mixing indications can be printed on the IML. The measurement and/or mixing indications can be similar to those described above for the liner.

The cup is preferably manufactured from a translucent or transparent material. The material of the cup preferably has a haze value, measured in accordance with the ASTM D1003 standard, lying between 0.4 and 3%, more preferably 0.4 and 1.5%. The transparency of the material of the cup preferably amounts to between 70 and 100%, more preferably between 80% and 100%.

The shape of the liner preferably closely fits the shape of the cup so that substantially the whole outer wall of the liner makes contact with the inner wall of the cup after the liner has been filled with liquid. More preferably, at least 90%, preferably at least 95% (or even 100%) of the bottom of the liner makes contact with the bottom of the cup, and/or at least 80%, preferably at least 90% of the upright side wall of the liner makes contact with the upright side wall of the cup, in the liquid-filled state. In this way it will be possible to accurately read the quantity of liquid in the cup, and the liner is supported in a stable manner by the cup.

The cup is preferably manufactured from a polypropylene material. The cup preferably has a side wall with a wall thickness greater than 500 micrometres.

The cup can optionally have a bottom which is provided with one or more openings, for instance a plurality of openings distributed along the periphery of the bottom. In a possible embodiment at least four holes, preferably at least six holes, are provided in the bottom of the cup, which holes can for instance be provided at a regular distance from each other. In another possible embodiment one hole, for instance a round hole or a hole with the shape of a ring segment, is provided in the bottom of the cup. This hole preferably has dimensions which allow one or more fingers to be placed through the hole in order to manipulate the liner. This can be particularly advantageous when a liner is reused.

According to yet another variant, one or more holes can be arranged in the upright side wall of the cup, preferably close to the bottom.

The cup can optionally have a bottom and an upright wall which is provided with a step-like upper end, wherein the step-like upper end comprises a first peripheral wall which lies at an angle relative to a part of the upright wall lying thereunder, and a second peripheral wall which is connected to the first peripheral wall and lies at an angle relative to the first peripheral wall, wherein the liner supports on the first peripheral wall of the cup. The first peripheral wall is preferably substantially parallel to the bottom or forms an angle smaller than 20° with a plane parallel to the bottom. The first peripheral wall preferably lies at an angle of between 70° and 110° relative to a part of the upright wall lying thereunder; and/or the second peripheral wall preferably lies at an angle of between 70° and 110° relative to the first peripheral wall.

Further embodiments of the invention are described in the clauses below:
1. An assembly comprising
   a lid (100) with a passage (110) for a liquid, wherein the passage is preferably configured to be coupled to a spray gun (300) for spraying the liquid,
   a cup (200), and
   a liner (400) for receiving the liquid, wherein the liner is configured to be arranged in the cup;
   wherein the lid (100) is configured to be removably couplable to the cup (200), all this such that in a coupled state of the lid on the cup an upper end (410) of the liner is clamped between the lid and the cup;
   wherein the lid (100) is provided with an inner peripheral wall (120) which is configured to extend at least partially into the cup, wherein the inner peripheral wall has an outer surface (122) lying opposite an inner surface (221) of the cup;
   wherein the outer surface (122) of the inner peripheral wall and/or the inner surface (221) of the cup is provided with at least one seal (500), such that the upper end of the liner is clamped sealingly between the cup and the inner peripheral wall of the lid.
2. The assembly according to clause 1, wherein the outer surface (122) of the inner peripheral wall is formed with the at least one seal (500).
3. The assembly according to clause 1 or 2, wherein the at least one seal (500) comprises an annular seal which protrudes from the outer surface (122) of the inner peripheral wall and/or an annular seal which protrudes from the inner surface (221) of the cup.
4. The assembly according to any one of the foregoing clauses, wherein the lid is provided with an upper wall (130) which is configured to extend over an upper end of the cup, wherein the upper wall has an inner surface (131) lying opposite an upper surface (231) close to the upper end of the cup; wherein the inner surface (131) of the upper wall and/or the upper surface (231) of the cup is provided with at least one further seal (600), such that the upper end of the liner is clamped sealingly between the cup and the upper wall of the lid.
5. The assembly according to the foregoing clause, wherein the inner surface (131) of the upper wall is formed with the at least one further seal.
6. The assembly according to clause 4 or 5, wherein the at least one further seal (600) comprises an annular seal which protrudes from the inner surface of the upper wall and/or an annular seal which protrudes from the upper surface of the upper end of the cup.
7. The assembly according to any one of the foregoing clauses, wherein the lid is provided with an outer peripheral wall (140) which is configured to be in contact with an outer surface (242) of the cup.
8. The assembly according to the foregoing clause, wherein the outer surface (242) of the cup is provided with and particularly formed with a screw thread (250), and wherein an inner surface (141) of the outer peripheral wall (140) is provided with and particularly formed with a complementary screw thread (150).
9. Assembly comprising
   a lid (100) with a passage (110) for a liquid, wherein the passage is preferably configured to be coupled to a spray gun (300) for spraying the liquid,
   a cup (200), and
   a liner (400) for receiving the liquid, wherein the liner is configured to be arranged in the cup;
   wherein the lid (100) is configured to be removably couplable to the cup (200), all this such that in a coupled state of the lid on the cup an upper end of the liner is clamped between the lid and the cup;
   wherein the cup has a bottom and an upright wall (205) which is provided with a step-like upper end (210), wherein the step-like upper end (210) comprises a first peripheral wall (230) which lies at an angle relative to a part of the upright wall lying thereunder, and a second peripheral wall (240) which is connected to the first peripheral wall (230) and lies at an angle relative to the first peripheral wall, wherein the liner (400) is clamped between the first peripheral wall (230) of the cup (200) and the lid (100).
10. The assembly according to the foregoing clause, wherein the first peripheral wall (230) is substantially parallel to the bottom or forms an angle smaller than 20° with a plane parallel to the bottom.
11. The assembly according to clause 9 or 10, wherein the first peripheral wall lies at an angle of between 70° and 110° relative to a part of the upright wall lying thereunder; and/or wherein the second peripheral wall (240) lies at an angle of between 70° and 110° relative to the first peripheral wall.
12. The assembly according to any one of the clauses 9-11, wherein the lid is provided with an upper wall (130) which is configured to extend over the first peripheral wall (230), wherein the upper wall has an inner surface (131) lying opposite an upper surface (231) of the first peripheral wall;
   wherein the inner surface of the upper wall and/or the upper surface of the first peripheral wall is provided with, preferably formed with, at least one seal (600) such that the upper end of the liner is clamped sealingly between the cup and the upper wall of the lid.
13. The assembly according to any one of the clauses 9-12, wherein the lid (100) is provided with an inner peripheral wall (120) which is configured to extend at least partially into the cup, wherein the inner peripheral wall has an outer surface (122) lying opposite an inner surface (221) of the cup;
   wherein the outer surface of the inner peripheral wall and/or the inner surface of the cup is provided with at least one seal (400), such that the upper end of the liner is clamped sealingly between the cup and the inner peripheral wall of the lid.
14. The assembly according to any one of the clauses 9-13, wherein the lid is provided with an outer peripheral wall (140) which is configured to be in contact with the second peripheral wall (240) of the cup.
15. The assembly according to the foregoing clause, wherein the second peripheral wall (240) is provided with and particularly formed with a screw thread (250), and wherein the outer peripheral wall (140) of the lid is provided with and particularly formed with a complementary screw thread (150).
16. An assembly comprising
   a lid (100) with a passage (110) for a liquid, wherein the passage is preferably configured to be coupled to a spray gun (300) for spraying the liquid,
   a cup (200) with a bottom and an upright side wall, and
   a liner (400) for receiving the liquid, wherein the liner is configured to be arranged in the cup;
   wherein the lid (100) is configured to be removably couplable to the cup (200), all this such that in a coupled state of the lid on the cup an upper end of the liner is clamped between the lid and the cup;
   wherein the liner is manufactured from a polyethylene terephthalate (PET) material.
17. An assembly comprising
   a lid (100) with a passage (110) for a liquid, wherein the passage is preferably configured to be coupled to a spray gun (300) for spraying the liquid,
   a cup (200) with a bottom and an upright side wall, and
   a liner (400) for receiving the liquid, wherein the liner is configured to be arranged in the cup;
   wherein the lid (100) is configured to be removably couplable to the cup (200), all this such that in a coupled state of the lid on the cup an upper end of the liner is clamped between the lid and the cup; wherein the liner has a cup shape with a jacket with a wall thickness lying between 10 and 250 micrometres, preferably between 10 and 200 micrometres, still more preferably between 10 and 150 micrometres.
18. An assembly comprising
   a lid (100) with a passage (110) for a liquid, wherein the passage is preferably configured to be coupled to a spray gun (300) for spraying the liquid,
   a cup (200) with a bottom and an upright side wall, and
   a liner (400) for receiving the liquid, wherein the liner is configured to be arranged in the cup;
   wherein the lid (100) is configured to be removably couplable to the cup (200), all this such that in a coupled state of the lid on the cup an upper end of the liner is clamped between the lid and the cup;
   wherein the liner has a cup shape and is manufactured from a material with an elastic modulus, measured in accordance with testing method ISO 527-2, lying between 1000 MPa and 4000 MPa, preferably between 2000 MPa and 3000 Mpa.
19. The assembly according to any one of the foregoing clauses, wherein a ratio of the weight of the liner and the volume which can be received in the liner lies between 3 g/l and 16 g/l, preferably between 4 g/l and 10 g/l.
20. The assembly according to any one of the foregoing clauses, wherein the weight of the liner lies between 1 g and 6 g, preferably between 1 g and 5 g, still more preferably between 2 g and 5 g.
21. The assembly according to any one of the foregoing clauses, wherein the volume of liquid which can be received in the liner preferably lies between 200 and 900 ml.
22. The assembly according to any one of the foregoing clauses, wherein the cup is manufactured from a polypropylene material.
23. The assembly according to any one of the foregoing clauses, wherein the cup has a side wall with a wall thickness greater than 500 micrometres.
24. The assembly according to any one of the foregoing clauses, wherein the liner (400) has a bottom (401), an upright side wall (405) and a peripheral flange (430), which peripheral flange protrudes outward from the upright side wall and is intended to extend between the cup and the lid.
25. The assembly according to any one of the foregoing clauses, wherein the liner has the shape of a cup with an upright side wall (405) which is provided with a bend (420), all this such that when the liner (400) is placed in a second, identical liner (400′), the bend is supported on an upper end (430′) of the second liner.
26. The assembly according to any one of the foregoing clauses, wherein the lid has a conical or spherical part (160) which lies adjacently of the passage (110).
27. The assembly according to any one of the foregoing clauses, further comprising a filter (700) for filtering liquid flowing from the liner to the passage.
28. The assembly according to any one of the foregoing clauses, wherein the filter is arranged against an underside of the lid.
29. The assembly according to any one of the foregoing clauses, wherein the cup is formed with a bottom (201) and an upright wall (205) extending from the bottom (201), wherein the bottom is provided with one or more openings (202), preferably a plurality of openings distributed along the periphery of the bottom.
30. The assembly according to any one of the foregoing clauses, further comprising a stopper (800) or a cap configured to be removably arrangeable on or in the passage in the lid in order to close the passage.
31. The assembly according to the foregoing clause, wherein the stopper is provided with a cylindrical part (801) which can be inserted sealingly into the passage, and an upper flange (802) which protrudes outward relative to the cylindrical part.
32. Liner for use in an assembly according to any one of the foregoing clauses.
33. Cup for use in an assembly according to any one of the clauses 1-31.
34. Lid for use in an assembly according to any one of the clauses 1-31.
35. Cap or stopper for use in an assembly according to any one of the clauses 1-31.

### BRIEF DESCRIPTION OF THE FIGURES

The above stated and other advantageous features and objects of the invention will become more apparent, and the invention better understood, on the basis of the following detailed description when read in combination with the accompanying drawings, in which:

FIG. 1 illustrates a schematic perspective view of an embodiment of an assembly of a cup, liner and lid mounted on a paint spray gun;

FIG. 2 illustrates a cross-sectional view of an embodiment of an assembly;

FIG. 3 shows a detail view X of FIG. 2;

FIGS. 4A and 4B illustrate perspective views of an embodiment of a cup when looking at respectively an upper end and the bottom;

FIG. 4C illustrates two stacked cups according to a possible embodiment;

FIG. 4D illustrates a detail of FIG. 4C;

FIGS. 5A and 5B illustrate perspective views of an embodiment of a lid when looking at respectively an upper side and an underside;

FIG. 6 shows a perspective view of an embodiment of a stopper;

FIGS. 7A and 7B illustrate respectively a perspective view and a cross-sectional view of another embodiment of a lid;

FIG. 7C illustrates a perspective view of a variant of the embodiment of FIGS. 7A and 7B;

FIGS. 8A, 8B, 8C illustrate respectively a cross-section of an embodiment of a liner, a cross-section of an embodiment of a cup, and a cross-section of two stacked liners;

FIGS. 9A, 9B, 9C illustrate respectively a cross-section of another embodiment of a liner, a cross-section of another embodiment of a cup, and a cross-section of two stacked liners;

FIGS. 10A, 10B, 10C and 10D show cross-sectional detail views of four variants of an assembly of a cup, a liner, a lid and an optional filter; and

FIG. 11 illustrates an example of measurement and mixing indications which can be applied to a liner and/or to a cup.

### DETAILED DESCRIPTION OF EMBODIMENTS

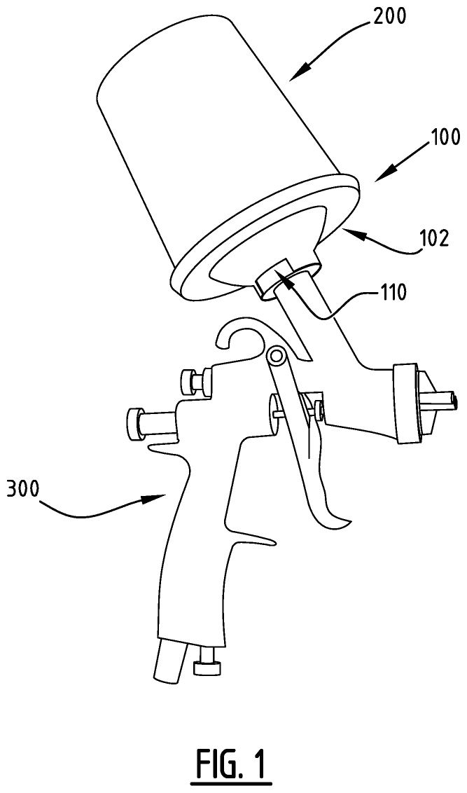

FIG. 1 illustrates an assembly of a lid 100, a cup 200 and a liner (not visible in FIG. 1). The assembly is mounted upside down on a paint spray gun 300, wherein the lid 100 is coupled to an inlet of the paint spray gun 300. According to a typical method, the liner in cup 200 is filled with liquid, typically a viscous liquid such as paint, after which lid 100 is arranged on cup 200. The connection between lid 100 and cup 200 is preferably liquid-tight or substantially liquid-tight, wherein the liner is clamped between lid 100 and cup 200. Lid 100 is provided with a passage 110 through which liquid can flow from cup 200 to a channel of paint spray gun 300. The upper side 102 of lid 100 can for this purpose be configured to be coupled to paint spray gun 300. The pressure in the liner decreases as liquid is removed from the liner. By providing one or more openings in the cup or in the lid, the cup is ventilated and the liner is compressed.

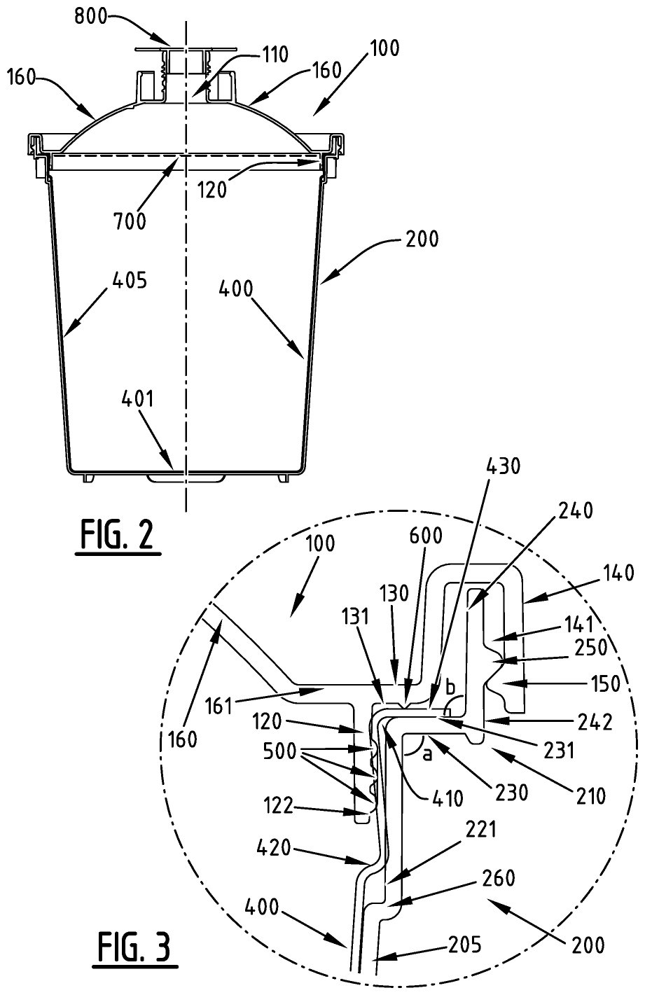

An exemplary embodiment of an assembly according to the invention is illustrated in FIGS. 2, 3, 3A-3B, 4A-4B, 5, 6, 8A-8C. FIG. 2 shows the whole assembly. The assembly comprises a lid 100, a cup 200, a liner 400 and an optional cap 800. The lid 100 has a passage 110 for a liquid, wherein the passage is preferably configured to be coupled to a spray gun 300 for spraying the liquid, as was elucidated above. The liner 400 is intended to receive the liquid and is configured to be arranged in cup 200. Lid 100 is removably couplable to cup 200, all this such that in a coupled state of lid 100 on cup 200 an upper end 410 of liner 400 is clamped between lid 100 and cup 200, see FIG. 3.

The lid 100 is provided with an inner peripheral wall 120 which is configured to extend at least partially into cup 200, wherein the inner peripheral wall 120 has an outer surface 122 which lies opposite an inner surface 221 of cup 200. The outer surface 122 of the inner peripheral wall 120 and/or the inner surface 221 of cup 200 is provided with at least one seal 500 such that the upper end 410 of liner 400 is clamped sealingly between cup 200 and the inner peripheral wall 120 of lid 100. In the illustrated embodiment the outer surface 122 of the inner peripheral wall 120 is formed with three seals 500, although the skilled person will appreciate that it is also possible to provide more or fewer seals 500. It is also possible to provide just one or more seals 500 on the inner surface 221 of cup 200 or to provide one or more seals 500 both on the inner surface 221 of cup 200 and on the outer surface 122 of the inner peripheral wall 120. The seal 500 is preferably an annular seal which protrudes from the outer surface 122 of the inner peripheral wall 120 and/or an annular seal which protrudes from the inner surface 221 of cup 200.

Lid 100 has an upper wall 130 which is configured to extend over an upper end of the cup. The inner peripheral wall 120 extends downward from the upper wall 130, into cup 200. The upper wall 130 has an inner surface 131 which lies opposite an upper surface 231 of an upper end 210 of cup 200. The upper end 210 of cup 200 can for instance be embodied with a substantially horizontally directed peripheral flange 230 with an upper surface 231 which lies opposite the upper wall 130. The inner surface 131 of the upper wall 130 and/or the upper surface 231 of cup 200 can be provided with at least one further seal 600 such that the upper end 410 of liner 400 is clamped sealingly between cup 200 and the upper wall 130 of lid 100. In the illustrated variant the inner surface 131 of the upper wall 130 is formed with one further seal 600, although the skilled person will appreciate that it is also possible to provide a plurality of seals 600. It is also possible to provide just one or more seals 600 on the upper surface 231 of cup 200 or to provide one or more seals 600 both on the upper surface 231 of cup 200 and on the inner surface 131 of cup 100. The seal 600 is preferably an annular seal which protrudes from the inner surface 131 and/or an annular seal which protrudes from the upper surface 231 of cup 200.

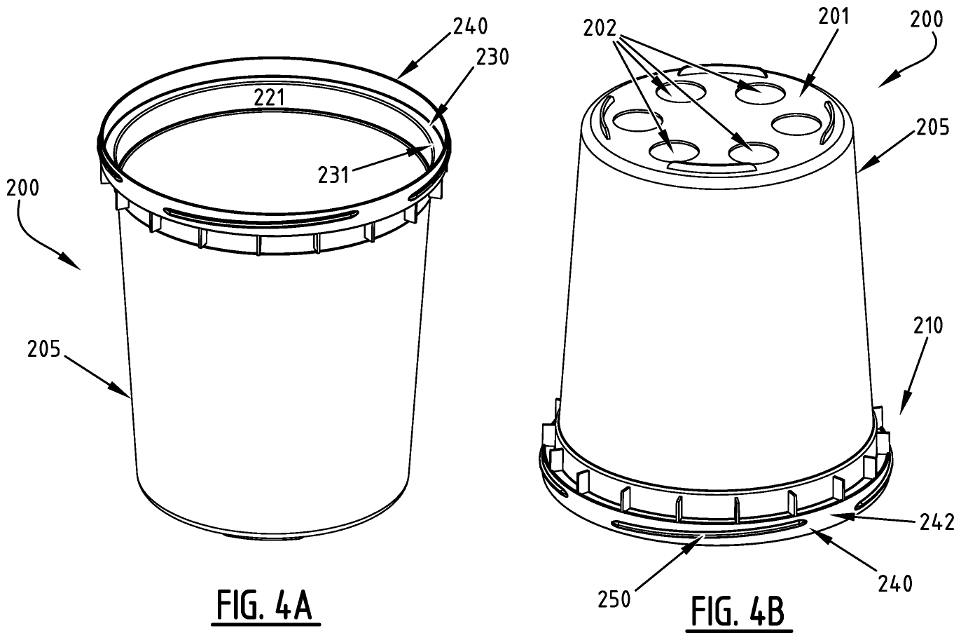

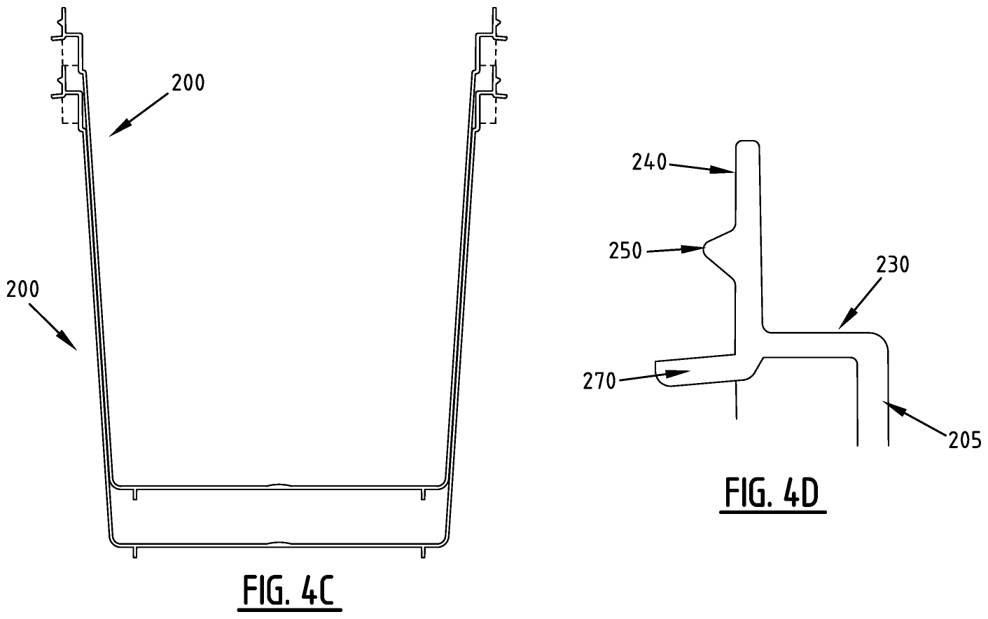

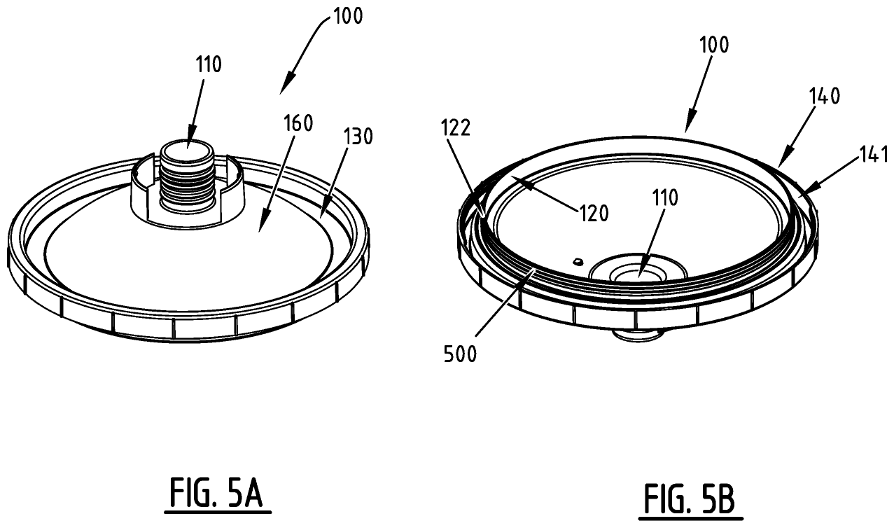

The lid 100 can further have an outer peripheral wall 140 which is configured to be in contact with an outer surface 242 of cup 200. The outer peripheral wall 140 and/or the outer surface 242 is preferably provided with coupling means for coupling lid 100 to cup 200. As visible in FIGS. 4A and 4B, the outer surface 242 of cup 200 can for instance be provided with and particularly be formed with one or more screw threads 250, preferably progressive screw threads. As visible in FIG. 3 and FIGS. 5A and 5B, an inner surface 141 of the outer peripheral wall 140 can then be provided with and particularly be formed with one or more complementary screw threads 150. In this way lid 100 can be screwed around cup 200 via a rotation movement. It is however also possible to provide other coupling means, such as for instance a snap-fit mechanism.

Lid 100 preferably has a conical or spherical part 160 which lies adjacently of the passage 110. In this way the liquid is guided easily to passage 110 during spraying. A filter 700 can optionally be provided for filtering liquid flowing from liner 400 to passage 110. The filter 700 can for instance be arranged against an underside of lid 100. Filter 700 can for instance be mounted against a flat peripheral part 161 which lies between the conical or spherical part 160 and the inner peripheral wall 120.

Filter 700 for instance takes the form of a screen mesh. If the lid comprises a conical or spherical part 160, a flat edge (not shown) against which filter 700 is mounted can optionally be provided on the inner side of the conical or spherical part. The diameter of filter 700 can thus be roughly the same as that of the whole lid 100, or can be smaller. The diameter of filter 700 can for instance lie between 50 mm and 120 mm. Filter 700 and liner 400 are preferably arranged such that the collapsed liner 400 does not touch the filter while the liner is being sprayed empty.

In the illustrated variant the cup 200 has a bottom 201 and an upright wall 205 which is provided with a step-like upper end 210. The step-like upper end 210 comprises a first outward protruding peripheral wall 230 which lies at an angle a (here about 90°, preferably between 70° and 110°) relative to a part of the upright wall 205 lying thereunder, and a second peripheral wall 240 which is connected to the first peripheral wall 230 and lies at an angle b (here about 90°, preferably between 70° and 110°) relative to the first peripheral wall 230. Liner 400 is clamped between the first peripheral wall 230 of cup 200 and the lid 100. The first peripheral wall 230 is preferably substantially parallel to the bottom 201 or forms an angle smaller than 20° with a plane parallel to bottom 201. The upper wall 130 has an inner surface 131 which lies opposite an upper surface 231 of the first peripheral wall 230 and the inner surface 131 is provided with, preferably formed with, at least one seal 600 such that the upper end 410 of liner 400 is clamped sealingly between cup 200 and the upper wall 130 of lid 100. The outer peripheral wall 140 preferably bounds a U-shaped channel in which the second peripheral wall part 240 is received. The upper wall 130 thus runs upward in outward direction and transposes into the outer peripheral wall 140 and so forms a peripheral channel with a U-shaped cross-section which is open at the bottom.

FIG. 4C illustrates a variant of the cup 200 of FIGS. 4A and 4B, wherein two cups 200 are stacked one in the other. The cup is substantially identical to the cup of FIGS. 4A and 4B, with the difference that a flange 270 protruding outward from the second peripheral wall 240 is provided, see the detail shown in FIG. 4D. The flange 270 can be a peripheral flange which extends along the whole periphery. According to a variant, a plurality of outward-protruding flanges 270 can be provided. These one or more flanges 270 lie lower than the screw thread 250 and are configured to form a stop for lid 100, and particularly for the outer peripheral wall 140 of lid 100. In this way it is possible to prevent the lid from being screwed too tightly onto the cup.

Liner 400 is preferably manufactured from a polyethylene terephthalate (PET) material. Liner 400 is preferably obtained by thermoforming a PET film. Liner 400 has a cup shape with a bottom 401, an upright side wall or jacket 405 and a peripheral flange 430 protruding outward from the side wall 405. During thermoforming a pressure die is pressed against a PET film while a periphery of the PET film is being held. By controlling the speed at which the die moves in a suitable manner it is possible to ensure that the bottom has a wall thickness which is similar to that of the upright side wall, or which is slightly smaller or greater. The jacket 405 preferably has a wall thickness lying between 10 and 250 micrometres, preferably between 10 and 200 micrometres, still more preferably between 10 and 150 micrometres, most preferably between 40 and 150 micrometres. The bottom 401 preferably has a wall thickness of between 10 and 300 micrometres. The peripheral flange 340 is typically thicker and can for instance have a wall thickness of between 300 and 500 micrometres. Liner 400 is preferably manufactured from a material with an elastic modulus, measured in accordance with testing method ISO 527-2, lying between 1000 MPa and 4000 MPa, preferably between 2000 MPa and 3000 Mpa. A ratio of the weight of liner 400 and the volume which can be received in liner 400 preferably lies between 3 g/l and 16 g/l, preferably between 4 g/l and 10 g/l. The weight of liner 400 can for instance lie between 1 g and 6 g, preferably between 1 g and 5 g, still more preferably between 2 g and 5 g. The volume of liquid receivable in liner 400 can for instance lie between 200 and 900 ml. Liner 400 is preferably manufactured from a material with a specific weight, measured at 23° C. in accordance with the ISO 1183 measuring method, which is greater than 1 g/cm³, and which more preferably lies between 1 and 3 g/cm³.

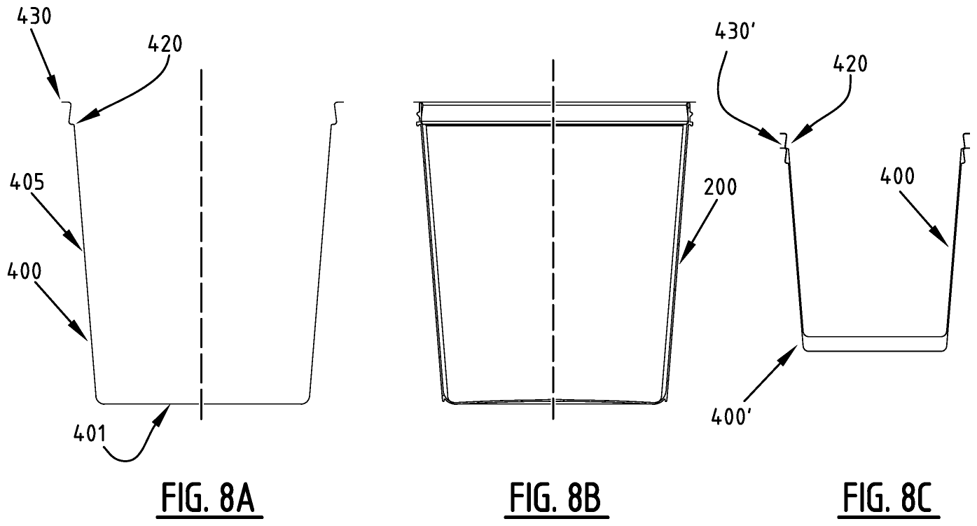

A bend 420 is preferably provided in upright side wall 405, all this such that when liner 400 is placed in a second, identical liner 400′, the bend 420 is supported on an upper end 430′ of the second liner 400′, see FIGS. 8A and 8C. Bend 420 thus forms a stacking edge whereby the liners 400, 400′ are easily stackable. Cup 200 and can then be provided with a corresponding bend 260 in the upright wall 205 thereof, such that liner 400 can be positioned properly in the cup 200, see also FIGS. 2 and 3.

Cup 200 can for instance be manufactured from a polypropylene material. Cup 200 has a bottom 201 and an upright side wall 205 with a wall thickness which is preferably greater than 500 micrometres, for instance between 600 and 700 micrometres. As visible in FIG. 4B, the bottom 201 is provided with one or more ventilation openings 202, preferably a plurality of ventilation openings distributed along the periphery of bottom 201. According to another possible embodiment, one or more openings can be provided in the upright wall 205 of cup 200 and/or in lid 100.

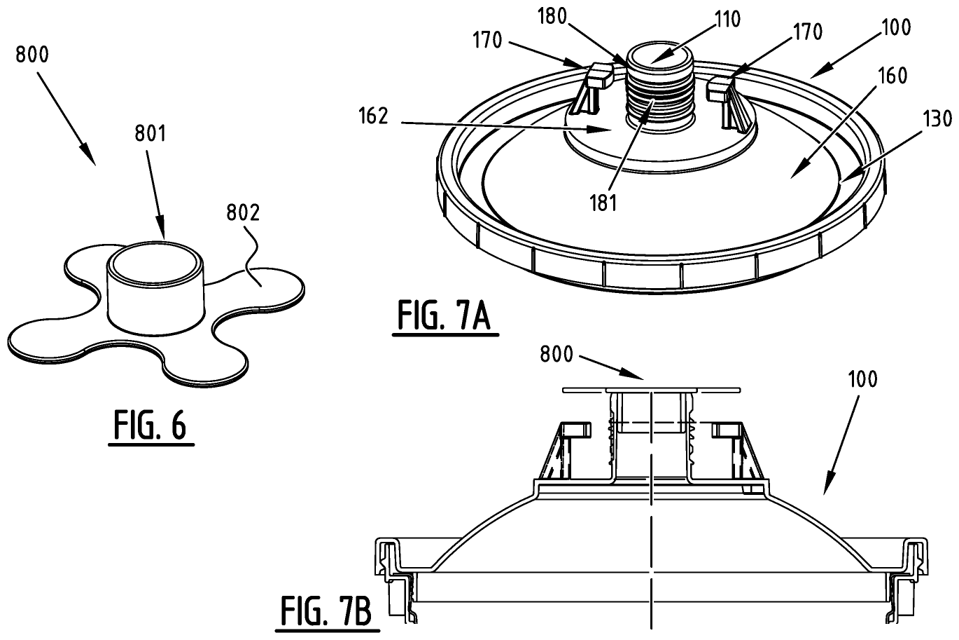

FIG. 2 shows that the assembly can optionally further comprise a stopper 800 or a cap, which is configured to be removably arrangeable on or in the passage 110 in lid 100 in order to close passage 110. The stopper 800 is shown in detail in FIG. 6. Stopper 800 is provided with a substantially cylindrical or conical part 801 which can be inserted sealingly into passage 110, and an upper flange 802 which protrudes outward relative to the cylindrical or conical part 801. The upper flange 802 provides for a simple placing and removal of the stopper 800 by a user.

The upper flange 802 preferably has a flat upper side such that the assembly can also be placed upside down, wherein the support surface is formed by the upper flange 802 of stopper 800. The upper flange preferably extends diametrically relative to the cylindrical or conical part 801 over a distance of at least 5 mm, more preferably at least 7.5 mm, for instance more than 10 mm. The upper flange 802 can for instance be formed with four protruding legs or wings which are arranged distributed uniformly around a central axis of the cylindrical or conical part 801 and are configured to form a support when the assembly is placed upside down on a flat surface. In the shown example four protruding wings are provided, although the skilled person will appreciate that more or fewer wings can also be provided, and that it is also possible to use a round upper flange 802. In this way the assembly can be placed on the cap or stopper 800 following spraying if any paint remains in the cup, such that if a filter is present, this filter remains submerged and does not dry out.

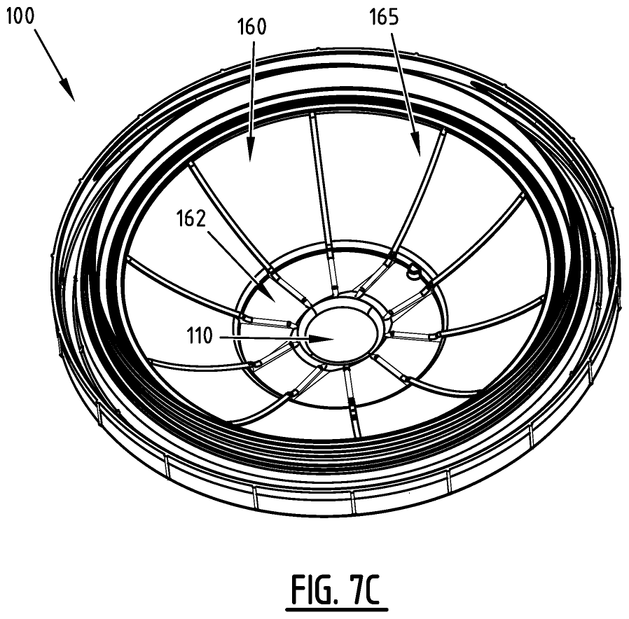

FIGS. 7A and 7B illustrate a variant of the lid 100 of FIGS. 5A and 5B in which similar components are designated with the same reference numerals. The upper wall 130 of the lid is here provided with a central flat part 162 around passage 110, on which two wings 170 are arranged at a distance from passage 110. Passage 110 is bounded by a cylindrical part 180 which protrudes from the central flat part 162. Protruding rings 181 are provided on the cylindrical part 180. These wings 170 and rings 181 provide for a good coupling of lid 100 to the paint spray gun.

FIG. 7C shows a further variant of the embodiment of FIGS. 7A and 7B, wherein strengthening ribs 165 are arranged on an inner side of lid 100, and here both on an inner side of the conical or spherical part 160 and on an inner side of the central flat part 162.

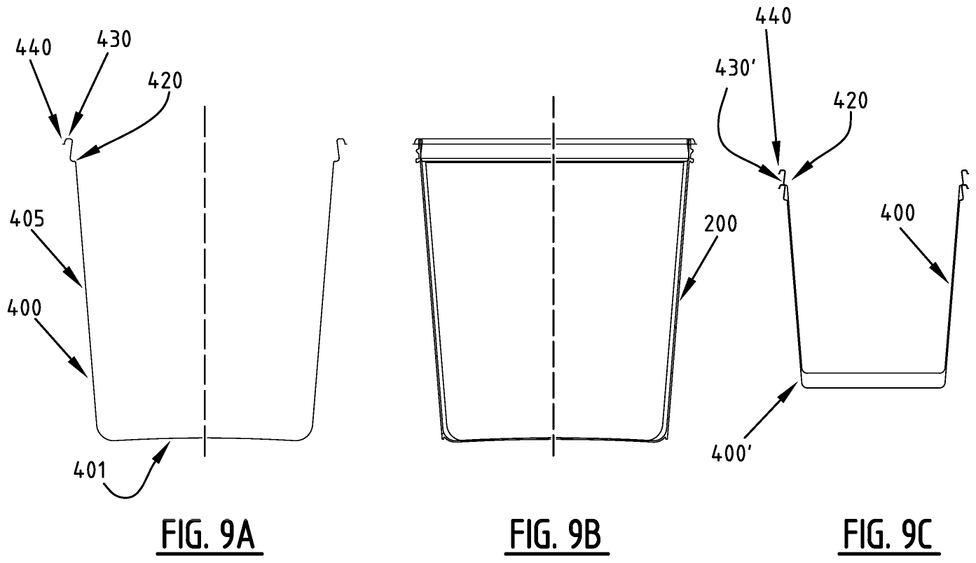

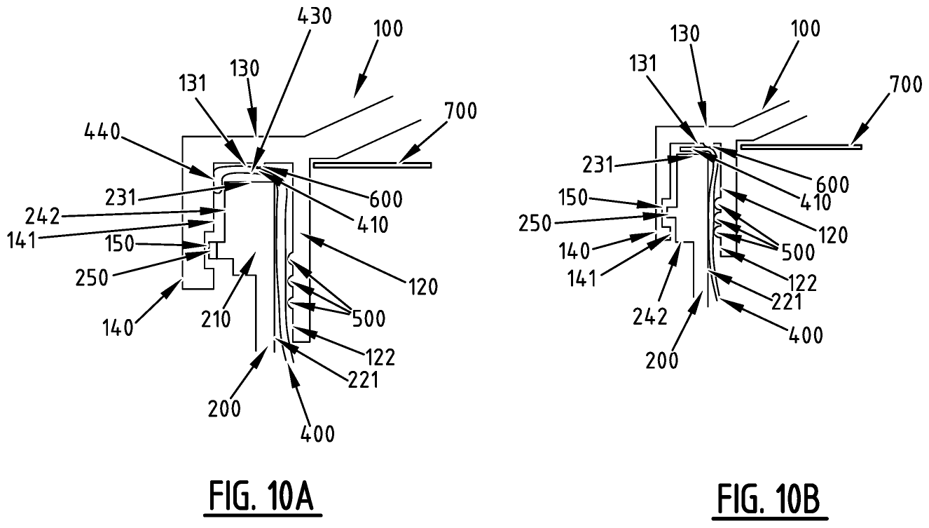

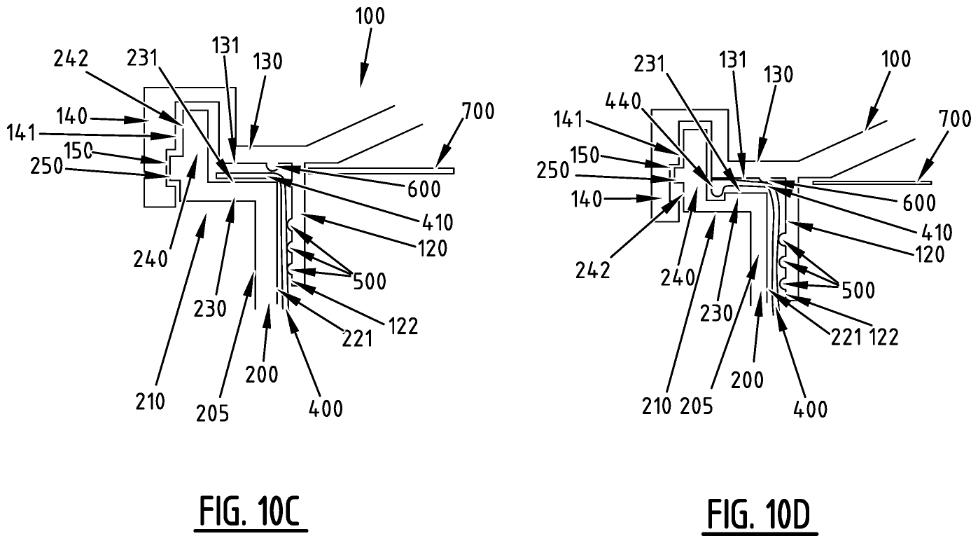

FIGS. 9A-9C illustrate a variant of the liner 400 and the cup 200 of FIGS. 8A-8C, in which similar components are designated with the same reference numerals. Liner 400 is here provided with a folded border 440 which extends up to an outer surface 242 of cup 200, see also the variant of FIG. 10A discussed below. The folded border 440 is provided on an outer edge of peripheral flange 430 and extends downward from the peripheral flange 430. In this way an excellent positioning of liner 400 in cup 200 can be obtained.

FIGS. 10A-10D illustrate four variants for the connection and sealing of liner 400 between lid 100 and cup 200, in which similar components are designated with the same reference numerals. In the variant of FIG. 10A a liner with a folded border 440 is used and seals 500 and 600 are provided in a manner which is similar to that described for FIG. 2. The cup is further provided with a screw thread 250 and an inner side 141 of the outer peripheral wall 140 is provided with a complementary groove 150 so that lid 100 can be fastened onto cup 200 by screwing. The upper end 210 of cup 200 here takes a thickened form for the purpose of forming an upper surface 231 opposite the inner surface 131 of the upper wall 130 of lid 100. In this way the seal 600 can press an upper end 410 of liner 400 against upper surface 231. The variant of FIG. 10B is similar to that of FIG. 10A, with the difference that liner 400 does not have a folded border. The variant of FIG. 10C is similar to that of FIG. 10B, with the difference that the upper end 210 of cup 200 takes a step-like form here, with a first peripheral wall part 230 and a second peripheral wall part 240, and that the lid 100 is provided with an outer peripheral wall 140 which bounds a U-shaped channel in which the second peripheral wall part 240 is received. In this way the wall thickness of the upper end 210 of cup 200 can be thinner than in the variant of FIG. 10B. The variant of FIG. 10D is similar to that of FIG. 10C, with the difference that liner 400 has a folded border 440 and that the upper surface 231 is provided with a groove in which the folded border 440 is receivable.

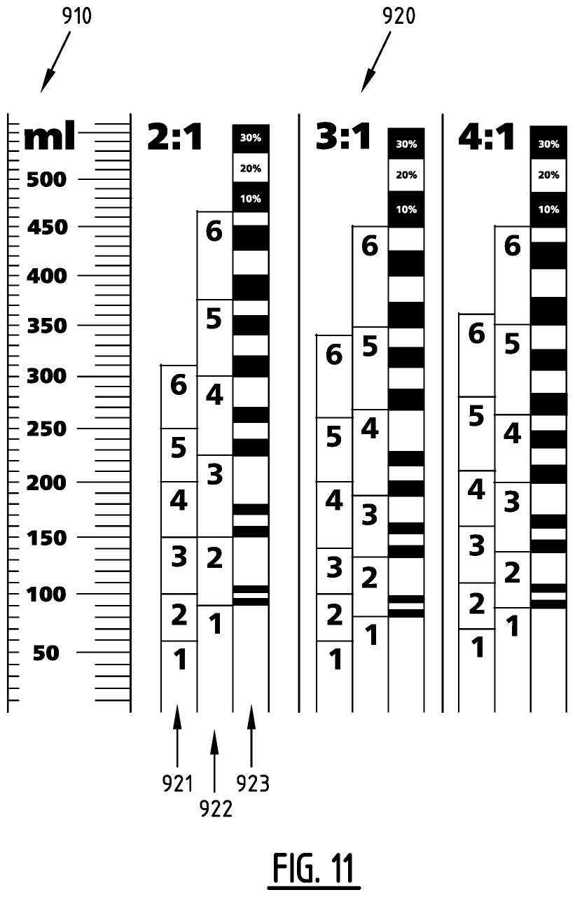

FIG. 11 illustrates an example of measurement indications 910 and mixing indications 920 which can be applied to cup 200 and/or to liner 400. They can for instance be printed onto liner 400 and/or cup 200, or be arranged via an IML. Measurement indications 910 indicate the quantity of liquid in liner 400. Mixing indications can for instance comprise a first indication 921 for a quantity of first liquid and a second indication 922 for a quantity of added second liquid, and optionally a third indication 923 for adding a third liquid (here for instance 10, 20 or 30% diluting agent). The mixing indications 920 can for instance comprise indications for a 2:1, 3:1, etc. mixing ratio.

Embodiments of the invention can be used for any 2-component (2K) systems wherein use is for instance made of a basic component (for instance a varnish), a hardener and optionally a diluting agent.

The skilled person will appreciate that the invention is not limited to the above described embodiments and that many modifications and variants are possible within the scope of the invention, which is defined solely by the following claims.

1-39. (canceled)

40. A liner for receiving a liquid, such as a paint mixture, wherein the liner has the shape of a cup and is configured to be arranged in a cup; wherein the liner has a bottom, an upright side wall and a peripheral flange, which peripheral flange protrudes outward from the upright side wall and is intended to extend over an edge of the cup; wherein the liner is manufactured from a polyethylene terephthalate (PET) material; wherein the upright wall has a wall thickness lying between 10 and 250 micrometres; wherein a ratio of the weight of the liner and the volume which can be received in the liner lies between 2 g/l and 16 g/l; wherein the liner is manufactured from a material with an elastic modulus, measured in accordance with testing method ISO 527-2, lying between 1000 MPa and 4000 MPa.

41. The liner according to claim 40, wherein the wall thickness lies between 10 and 200 micrometres.

42. The liner according to claim 40, wherein the ratio of a height of the liner and a diameter of the liner is smaller than 1.7.

43. The liner according to claim 40, wherein the PET material has a haze value, measured in accordance with the ASTM D1003 standard, lying between 0.4 and 1.5% and/or wherein the transparency of the PET material amounts to between 80 and 100%.

44. The liner according to claim 40, wherein the ratio of the weight of the liner and the volume which can be received in the liner lies between 2.5 g/l and 16 g/l.

45. The liner according to claim 40, wherein the weight of the liner lies between 1 g and 6 g; and/or wherein the volume of liquid which can be received in the liner lies between 200 and 5000 ml.

46. The liner according to claim 40, wherein the upright side wall is provided with a bend, all this such that when the liner is placed in a second, identical liner, the bend is supported on an upper end of the second liner; and/or wherein the bottom of the liner extends in a substantially flat plane.

47. The liner according to claim 40, wherein the liner is provided with measurement indications and/or mixing indications.

48. An assembly comprising a liner and a cup in which the liner is receivable, wherein the cup is formed with a bottom and an upright wall extending from the bottom, and wherein the liner is configured for receiving a liquid, such as a paint mixture, wherein the liner has the shape of a cup and is configured to be arranged in a cup; wherein the liner has a bottom, an upright side wall and a peripheral flange, which peripheral flange protrudes outward from the upright side wall and is intended to extend over an edge of the cup; wherein the liner is manufactured from a polyethylene terephthalate material; wherein the upright wall has a wall thickness lying between 10 and 250 micrometres; wherein a ratio of the weight of the liner and the volume which can be received in the liner lies between 2 g/l and 16 g/l.

49. The assembly according to claim 48, wherein the cup is manufactured from a polypropylene material.

50. The assembly according to claim 48, wherein the upright side wall of the cup has a wall thickness greater than 500 micrometres.

51. The assembly according to claim 48, wherein the shape and dimensions of the liner are such that at least 90% of the bottom of the liner makes contact with the bottom of the cup, and/or at least 80% of the upright side wall of the liner makes contact with the upright side wall of the cup, in the liquid-filled state of the liner.

52. The assembly according to claim 48, wherein the bottom of the cup is provided with one or more openings, for instance a plurality of openings distributed along the periphery of the bottom or one opening through which a finger of a user can manipulate the liner.

53. The assembly according to claim 48, wherein the upright wall of the cup is provided with a step-like upper end, wherein the step-like upper end comprises a first peripheral wall which lies at an angle relative to a part of the upright wall lying thereunder, and a second peripheral wall which is connected to the first peripheral wall and lies at an angle relative to the first peripheral wall, wherein the liner supports on the first peripheral wall of the cup, wherein optionally the first peripheral wall lies at an angle of between 70° and 110° relative to a part of the upright wall lying thereunder; and/or wherein the second peripheral wall lies at an angle of between 70° and 110° relative to the first peripheral wall.

54. The assembly according to claim 48, further comprising a lid with a passage for the liquid, wherein the lid is configured to be removably couplable to the cup, all this such that in a coupled state of the lid on the cup an upper end of the liner is clamped between the lid and the cup, wherein optionally the lid has a conical or spherical part which lies adjacently of the passage.

55. The assembly according to claim 54, wherein the lid is provided with an inner peripheral wall which is configured to extend at least partially into the cup, wherein the inner peripheral wall has an outer surface lying opposite an inner surface of the cup; wherein the outer surface of the inner peripheral wall and/or the inner surface of the cup is provided with at least one seal, such that the upper end of the liner is clamped sealingly between the cup and the inner peripheral wall of the lid; and/or wherein the lid is provided with an upper wall which is configured to extend over an upper end of the cup, wherein the upper wall has an inner surface lying opposite an upper surface close to the upper end of the cup; wherein the inner surface of the upper wall and/or the upper surface of the cup is provided with at least one further seal, such that the upper end of the liner is clamped sealingly between the cup and the upper wall of the lid.

56. The assembly according to claim 55, wherein the lid is provided with an outer peripheral wall which is configured to be in contact with an outer surface of the cup.

57. The assembly according to claim 56, wherein the outer surface of the cup is provided with and particularly formed with a screw thread, and wherein an inner surface of the outer peripheral wall is provided with and particularly formed with a complementary screw thread.

58. The assembly according to claim 54, further comprising a filter for filtering liquid flowing from the liner to the passage, wherein the filter is arranged against an underside of the lid.

59. The assembly according to claim 54, further comprising a stopper or a cap configured to be removably arrangeable on or in the passage in the lid in order to close the passage, wherein the stopper is provided with a cylindrical or conical part which can be inserted sealingly into the passage, and an upper flange which protrudes outward relative to the cylindrical or conical part.
